(19) United States
(12) Patent Application Publication
(10) Pub. No.: US 2010/0247961 A1
(43) Pub. Date: Sep. 30, 2010

(54) PERPENDICULAR MAGNETIC RECORDING MEDIUM, METHOD OF MANUFACTURING THE MEDIUM AND MAGNETIC RECORDING AND REPRODUCING APPARATUS

(75) Inventors: Ryuji Sakaguchi, Chiba (JP); Gohei Kurokawak, Chiba (JP); Yuzo Sasaki, Chiba (JP); Tatsu Komatsuda, Chiba (JP); Amarendra K. Singh, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/525,943

(22) PCT Filed: Jan. 16, 2008
(86) PCT No.: PCT/JP2008/050841

§ 371 Date: Nov. 6, 2009

(30) Foreign Application Priority Data
Feb. 6, 2007 (JP) 2007-027095

(51) Int. Cl. G11B 5/33

(52) U.S. Cl. 428/800

(57) ABSTRACT

In a perpendicular magnetic recording medium having at least a soft magnetic back layer, an underlayer, an intermediate layer and a perpendicular magnetic recording layer on a nonmagnetic substrate, at least one layer in the intermediate layer contains Re as a main component element and contains, as a second main component element, an element having an hcp structure or an element having a bcc structure. The concentration of Re as the main component element of the intermediate layer is within the range from 55 to 99.5 atomic percent. The second component element is Co or Cr.

### CROSS REFERENCE TO RELATED APPLICATION

This application is an application filed under 35 U.S.C. §111(a) claiming the benefit pursuant to 35 U.S.C. §119(e)(1) of the filing date of Japanese Patent Application No. 2007-027095 filed Feb. 6, 2007 pursuant to 35 U.S.C. §111(b).

### TECHNICAL FIELD

The present invention relates to a perpendicular magnetic recording medium, a method of manufacturing the perpendicular magnetic recording medium and a magnetic recording and reproducing apparatus using such magnetic recording medium.

### BACKGROUND ART

In recent years, the range of application of magnetic recording apparatuses such as a magnetic disk drive, a flexible disk drive and a magnetic tape apparatus has been markedly increased and the importance of such apparatuses has been increased. Also, the recording density of magnetic recording mediums used in such apparatuses is now being largely increased. In particular, a steeper increase in areal recording density followed the introduction of a magneto-resistive (MR) head and a partial response maximum likelihood (RRML) technique. Since the introduction of a giant magneto-resistive (GMR) head and a tunneling magneto-resistive (TuMR) head in recent years, the recording density has increased at a pace of about 100% per year.

Under these circumstances, there is a demand for achieving a further increase in recording density in future with respect to magnetic recording mediums and, hence, a demand for achieving a higher coercive force, a higher signal-to-noise ratio (S/N ratio) and a higher resolution of a magnetic recording layer. In longitudinal magnetic recording system widely used heretofore, the self-demagnetization of recording magnetic domains, i.e., the action of each of an adjacent pair of recording magnetic domains in a magnetization transition region weakening the magnetization of the other, becomes dominant with increase in linear recording density. There is a need to increase the magnetic shape anisotropy in a magnetic recording layer by continually reducing the thickness of the magnetic recording layer in order to avoid the self-demagnetization.

On the other hand, as the film thickness of a magnetic recording layer is reduced, the magnitude of an energy barrier for maintaining magnetic domains and the magnitude of thermal energy become so closer in level to each other that a phenomenon in which a recorded amount of magnetization is relaxed under the influence of temperature (heat fluctuation phenomenon) is not negligible. This is said to be a determinant of the linear recording density.

In such circumstances, an anti-ferromagnetic coupling (AFC) medium has recently been proposed as a technical device to meet the demand for improving the linear recording density in the longitudinal magnetic recording system, and efforts are being put to avoid the thermal magnetization relaxation problem with longitudinal magnetic recording.

Perpendicular magnetic recording techniques are attracting attention as a promising technique for achieving a further increase in areal recording density. While a medium is magnetized in a direction along the surface of the medium in the conventional longitudinal magnetic recording system, a perpendicular magnetic recording system is characterized by magnetization in a direction perpendicular to the medium surface. Perpendicular magnetic recording is thought to be capable of avoiding the influence of self-demagnetization which is a hindrance to achievement of a higher linear recording density in the longitudinal magnetic recording system, and to be more suitable for recording at a higher density. Also, perpendicular magnetic recording is thought to be comparatively unsusceptible to thermal magnetization relaxation, which is the problem with longitudinal magnetic recording, because a certain magnetic layer thickness can be maintained in the case of perpendicular magnetic recording.

In ordinary cases, a perpendicular magnetic recording medium has an underlayer, an intermediate layer, a magnetic recording layer and a protective layer formed in this order on a nonmagnetic substrate. Also, in many cases, a lubricating layer is applied on the surface after film forming of the protective layer. Also, a magnetic film called a soft magnetic back layer is ordinarily provided under the underlayer. The intermediate layer is formed for the purpose of improving the characteristics of the magnetic recording layer. The underlayer is said to have the function of aligning crystals in the magnetic recording layer and the function of controlling the shape of a magnetic crystal.

The crystalline structure of a magnetic recording layer is important in manufacturing a perpendicular magnetic recording medium having excellent properties. In many cases of perpendicular magnetic recording mediums, a hexagonal closest-packed (hcp) structure is taken as the crystalline structure of a magnetic recording layer of the medium. However, it is important that the (002) crystal plane be parallel to the substrate surface, in other words, the crystal c-axis [002] axes be aligned in the perpendicular direction with least disturbance. However, while a perpendicular magnetic recording medium has the advantage of being capable of using a comparatively thick magnetic recording layer, the total film thickness of a thin film stack forming the entire medium tends to increase in comparison with the current longitudinal magnetic recording mediums, so that there is an increased possibility of a factor responsible for disturbance in crystalline structure being included in the medium layer stacking process.

To minimize disturbance in the crystalline structure of a magnetic recording layer, Ru which takes an hcp structure has been used as an intermediate layer in perpendicular magnetic recording mediums, as in conventional magnetic recording layers. Crystals in a magnetic recording layer are epitaxially grown on the Ru (002) crystal plane. Therefore a magnetic recording medium having improved crystal orientation can be obtained (see, for example, JP-A 2001-6158).

In ordinary cases, it is necessary to set the film thickness of an Ru intermediate layer to 10 nm or more in order to ensure sufficient separation between Co alloy crystals in a magnetic recording layer (see, for example, JP-A 2005-190517). However, an increase in crystal grain size of the Co alloy results from such a large-film-thickness setting, and the recording/reproduction characteristics deteriorate due to an increase in noise.

Other elements such as Ti, Hf and Zr and an Ru alloy taking an hcp structure as an intermediate layer have also been proposed for a further improvement in recording/reproduction characteristics. Such elements and alloy, however, are inadequate for obtaining a perpendicular magnetic recording medium in which both a reduction in grain size and the desired perpendicular alignment are achieved and which has improved recording/reproduction characteristics. There has been a demand for a perpendicular magnetic recording medium free from this problem and easily manufacturable.

Use of Re and an Re alloy as an intermediate layer has also been proposed. However, any improved perpendicular magnetic recording medium cannot be obtained in the case of using an Re intermediate layer, and no concrete example of the Re alloy has not been shown (see, for example, JP-A 2006-277950).

In view of the above-described circumstances, an object of the present invention is to provide a perpendicular magnetic recording medium in which a reduction in grain size and the desired perpendicular alignment are achieved to enable high-density information recording and reproduction, a method of manufacturing the magnetic recording medium and a magnetic recording and reproducing apparatus.

### DISCLOSURE OF THE INVENTION

To achieve the above-described object, the present invention provides a perpendicular magnetic recording medium, a method of manufacturing the magnetic recording medium and a magnetic recording and reproducing apparatus described below.

(1) A perpendicular magnetic recording medium having at least a soft magnetic back layer, an underlayer, an intermediate layer and a perpendicular magnetic recording layer on a nonmagnetic substrate, wherein at least one layer in the intermediate layer contains Re as a main component element and contains, as a second main component element, an element having an hcp structure or an element having a bcc structure.
(2) The perpendicular magnetic recording medium described in item (1), wherein the concentration of Re as a main component element of the intermediate layer is within the range from 55 to 99.5 atomic percent.
(3) The perpendicular magnetic recording medium described in item (1) or (2), wherein the second main component element is Co or Cr.
(4) The perpendicular magnetic recording medium described in any one of items (1) to (3), wherein the concentration of the second main component element is within the range from 0.5 to 45 atomic percent.
(5) The perpendicular magnetic recording medium described in item (1), wherein at least one layer in the intermediate layer contains Re as a main component element and contains, as additive elements, two elements Co and Cr, and the total concentration of the additive elements is within the range from 5 to 45 atomic percent.
(6) The perpendicular magnetic recording medium described in item (5), wherein the content concentrations of Co and Cr are equal to each other.
(7) The perpendicular magnetic recording medium described in any one of items (1) to (6), wherein the intermediate layer contains at least one element selected from the 13th-group elements (B, Al, Ga, In, Ti) and 14th-group elements (C, Si, Ge, Sn, Pb) and the total content of the selected element or the sum total of the contents of the selected elements is higher than 0 atomic percent and equal to or lower than 30 atomic percent.
(8) A method of manufacturing the perpendicular magnetic recording medium described in any one of items (1) to (7), wherein the sputtering gas pressure is set to 3 Pa or higher at the time of sputtering film forming of the intermediate layer.
(9) The method of the manufacturing the perpendicular magnetic recording medium described in item (8), wherein O₂ gas or H₂O gas is added before or after film forming or during film forming at the time of sputtering film forming of the intermediate layer.
(10) A magnetic recording and reproducing apparatus having a magnetic recording medium and a magnetic head for recording information on the magnetic recording medium and reproducing information from the magnetic recording medium, wherein the magnetic recording medium is the magnetic recording medium described in any one of items (1) to (7).

According to the present invention, a perpendicular magnetic recording medium can be obtained in which the crystalline structure of a perpendicular magnetic layer, particularly the crystal c-axis of the hcp structure is aligned with an extremely small angular variance with respect to the substrate surface, in which the average grain size of crystal grains constituting the perpendicular magnetic layer is extremely fine, and which has improved high recording density characteristics.

The above and other objects, characteristic features and advantages of the present invention will become apparent to those skilled in the art from the description to be give herein below with reference to the accompanying drawings.

### BRIEF DESCRIPTION OF THE DRAWINGS

FIG. 1 is a diagram schematically showing the stacked structure of a perpendicular magnetic recording medium in accordance with the present invention; and

FIG. 2 is a diagram schematically showing a magnetic recording and reproducing apparatus using the perpendicular magnetic recording medium in accordance with the present invention.

### BEST MODE FOR CARRYING OUT THE INVENTION

The details of the present invention will be concretely described.

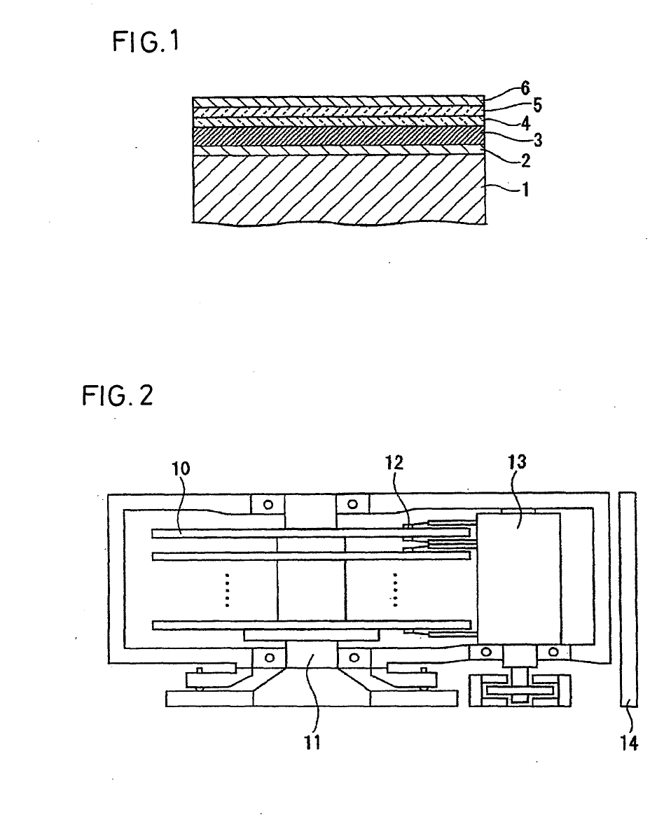

A perpendicular magnetic recording medium 10 in accordance with the present invention has, as shown in FIG. 1, on a nonmagnetic substrate 1, at least a soft magnetic back layer 2, an underlayer 3 and an intermediate layer 4 constituting an alignment control layer for controlling alignment of a film immediately above, a perpendicular magnetic layer 5 in which the axis of easy magnetization (crystal c-axis) is oriented mainly perpendicularly to the substrate, and a protective layer 6. The alignment control layer is constituted of a plurality of layers and has a structure including the underlayer 3 and the intermediate layer 4 from the substrate side. This structure can be applied to new types of perpendicular recording mediums such as an ECC medium, a piece of discrete track media and a piece of pattern media expected to have a further increased recording density in future.

As the nonmagnetic substrate used in the magnetic recording medium of the present invention, any nonmagnetic substrate such as an Al alloy substrate having Al as a main component, e.g., Al—Mg alloy, or a substrate formed of ordinary soda glass, aluminosilicate glass, amorphous glass, silicon, titanium, a ceramic, sapphire, quartz, or any of various resins. An Al alloy substrate or a glass substrate made of crystallized glass, amorphous glass or the like in particular is ordinarily used. In the case of a glass substrate, a mirror-polished substrate, a low-Ra substrate of Ra<1 Å or the like is preferable. The substrate may have a texture if it is insignificant.

In ordinary cases of a process of manufacturing a magnetic disk, cleaning and drying of a substrate are first performed. Also in the present invention, it is desirable, also from the viewpoint of ensuring adhesion of each layer, to perform cleaning and drying before forming the layer. Cleaning comprises cleaning by etching (inverse sputtering) as well as cleaning with water. The substrate size is not particularly specified.

Each of the layers of the perpendicular magnetic recording medium will now be described.

A soft magnetic back layer is provided in many perpendicular magnetic recording mediums. The soft magnetic back layer has the function of introducing a recording magnetic field from a head to efficiently apply the perpendicular component of the recording magnetic field to the magnetic recording layer at the time of recording of a signal on the medium. As the material of the soft magnetic back layer, a material having soft magnetic characteristics, e.g., a FeCo-based alloy, a CoZrNb-based alloy or a CoTaZr-based alloy may be used. It is particularly preferred that the soft magnetic layer is of an amorphous structure, because taking an amorphous structure is effective in preventing an increase in surface roughness: Ra and enables reducing the amount of floating of the head and further increasing the recording density. Not only the above-described single soft magnetic layer but also a combination of two soft magnetic layers between which an extremely thin nonmagnetic thin film of Ru or the like is interposed for AFC is finding use in many cases. The total thickness of the back layer is about 20 to 120 nm. However, it is determined according to balance between the recording and reproducing characteristics and OW characteristics.

In the present invention, the alignment control layer for controlling the alignment of the film immediately above is provided on the soft magnetic back layer. The alignment control layer is constituted of a plurality of layers called an underlayer and an intermediate layer from the substrate side.

In the present invention, it is preferred that the underlayer be of an hcp structure, a face-centered cubic (fcc) structure, a hexagonal system covalent-bond material or an amorphous structure. Also, it is preferred that the average grain size of crystal grains in the underlayer be within the range from 6 to 20 nm.

The intermediate layer of the present invention is used to perpendicularly align the magnetic recording layer with efficiency. It is preferred that the material be Re with an additive element having an hcp structure, e.g., Co, or an additive element having a body-centered cubic (bcc) structure, e.g., Cr provided in at least one layer, and that the content of the additive element in the intermediate layer be 0.5 to 45 atomic percent. The intermediate layer can be used as one layer in a stack of a certain number of layers. With the intermediate layer, a layer can be used which is formed of Ru, an Ru alloy or an alloy of an element having an fcc structure and an element having a bcc structure or an element having an hcp structure, and which has a (111) plane-oriented crystalline structure and a irregular layer lattice (stacking fault) based on a mixture of the fcc structure and the bcc structure or the hcp structure.

The crystal alignment in the magnetic recording layer stacked on the intermediate layer is generally determined by the crystal alignment in the intermediate layer. Therefore, alignment control in the intermediate layer is extremely important in manufacture of the perpendicular magnetic recording medium. Similarly, if the average grain size of crystal grains in the intermediate layer can be finely controlled, crystal grains in the magnetic recording layer successively formed on the intermediate layer are ordinarily made fine because they can easily take over the shape of the crystal grains in the intermediate layer. It is said that the finer the grain size of crystal grains in the magnetic recording medium, the higher the ratio of the intensities of a signal and noise: SNR.

The reason that Re is suitable for the intermediate layer is as described below. The intermediate layer is necessary for perpendicularly aligning the crystal c-axis [002] axes of the magnetic layer Co with efficiency. It is preferable to use as the intermediate layer Re having an a-axis lattice constant slightly larger than the a-axis lattice constant 2.51 A of Co in epitaxially growing Co. The a-axis lattice constant of Re is 2.76 A. In ordinary cases, the lattice constant of a magnetic layer having Co as a main component is slightly changed by mixing Pt or Cr. However, the lattice constant on the Re side can also be changed by mixing Co or Cr. Also, Re has a markedly high heat conductivity and enables in-film heat generated at the time of film forming to be released to the underlayer film and the substrate with efficiency to ensure that the heat in the surface is sunk when the magnetic oxide layer is formed. This effect is advantageous in forming the granular structure in the magnetic layer. Also, since Re has a markedly high melting point and high hardness, the intermediate layer surface easily becomes rough to facilitate making of the granular structure in a magnetic oxide layer. The melting point of Re in a single state is excessively high. It is, therefore, preferable to slightly reduce the melting point by mixing an additive element such as Co or Cr with Re.

In this way, axisymmetric crystal growth only along a normal to the substrate is also effected in the magnetic recording layer stacked on the intermediate layer, so that the crystal c-axis [002] axes are perpendicularly aligned with efficiency.

In the perpendicular magnetic recording medium of the present invention, at least one layer in the intermediate layer has Re as a main component element and including two elements Co and Cr as additive elements, and the total concentration of the additive elements is set within the range from 5 to 45 atomic percent, thereby achieving an improvement in c-axis alignment of the perpendicular magnetic film and producing finer grain size of crystal grains in the perpendicular magnetic film.

In the present invention, it is particularly preferable to equalize the content concentrations of Co and Cr in achieving the above-described effects.

In the perpendicular magnetic recording medium of the present invention, at least one element selected from the 13th-group elements (B, Al, Ga, In, Tl) or 14th-group elements (C, Si, Ge, Sn, Pb) may be added and the total content of the selected element or the sum total of the contents of the selected elements may be set higher than 0 atomic percent and equal to or lower than 30 atomic percent. In this way, a further improvement in c-axis alignment in the perpendicular magnetic film and a finer grain size of crystal grains in the perpendicular magnetic film can be achieved.

The magnetic recording layer is literally a layer in which a signal is actually recorded. As the material of the magnetic recording layer, a Co-based alloy thin film of CoCr, CoCrPt, CoCrPtB, CoCrPtB—X, CoCrPtB—X—Y, CoCrPt—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, CoCrPtTiO₂ or the like is ordinarily used. In particular, in a case where an oxide magnetic layer is used, an oxide takes a granular structure by surrounding magnetic Co crystal grains to weaken magnetic mutual action between the Co crystal grains and to thereby reduce noise. The crystalline structure and magnetic characteristics of this layer eventually determine recording and reproduction.

Since the magnetic recording layer takes a granular structure, it is preferable to provide pits and projections in the surface by increasing the gas pressure in film forming of the intermediate layer. By concentration of the oxide in the oxide magnetic layer on pit portions in the intermediate layer surface, the granular structure is formed. However, there is a risk of deterioration of the crystal alignment in the intermediate layer and an excessive increase in surface roughness as a result of increasing the gas pressure. For this reason, the intermediate layer is formed by being divided into a low gas pressure-formed layer and a high gas pressure-formed layer to strike balance between the alignment and the formation of surface pits/projections.

For film forming of each of the above-described layers, DC magnetron sputtering or RF sputtering is ordinarily used. An RF bias, a DC bias, a pulse DC or a pulse DC bias, O₂ gas and H₂ gas introduction and use of N₂ gas are also possible. The corresponding sputtering gas pressure may be determined so that the characteristics of the layer are optimized. In ordinary cases, the sputtering gas pressure is controlled in the range from about 0.1 to 30 (Pa) and is adjusted with respect to the performance of the medium.

The protective layer is a layer for protecting the medium from damage caused by contact with a head. Carbon film, SiO₂ film or the like is used as the protective layer. Carbon film is ordinarily used. For forming of the film, sputtering or plasma CVD for example is used. Plasma CVD has been ordinarily used in recent years. Magnetron plasma CVD can also be used. The film thickness is about 1 to 10 nm, preferably 2 to 6 nm, more preferably 2 to 4 nm.

A low-noise magnetic recording medium in which magnetic crystals are isolated from each other by an oxide while the desired crystal alignment is maintained can be made by adjusting the gas pressure in forming the high gas pressure-formed film in the intermediate layer and the gas pressure in film forming for the magnetic recording layer in particular. Preferably, the gas pressure is 3 Pa or higher. Ar is ordinarily used as a gas in the film forming. A small amount of O₂ gas or H₂O gas may be added to Ar gas. This added gas has the effect of more selectively collecting in pit portions in Re pits and projections the oxide for forming the granular structure in the oxide magnetic layer. The amount of O₂ gas added is preferably 0.1 to 20%, more preferably 0.1 to 8%.

FIG. 2 shows an example of a perpendicular magnetic recording and reproducing apparatus using the above-described perpendicular magnetic recording medium. The perpendicular magnetic recording and reproducing apparatus shown in FIG. 2 includes the magnetic recording medium 10 having the structure shown in FIG. 1, a medium drive unit 11 which drives and rotates the magnetic recording medium 10, a magnetic head 12 which records information on the magnetic recording medium 10 or reproduces information from the magnetic recording medium 10, a head drive unit 13 which moves the magnetic head 12 relative to the magnetic recording medium 10, and a recording and reproduction signal processing system 14.

The recording and reproduction signal processing system 14 can process data supplied from the outside to obtain a recording signal, supply the recording signal to the magnetic head 12, and process a reproduction signal from the magnetic head 12 to send data to the outside.

As the magnetic head 12 used in the magnetic recording and reproducing apparatus of the present invention, any of magnetic heads suitable for higher-density magnetic recording, not only those having magneto-resistance (MR) element provided as a reproducing element and using an anisotropic magnetic resistance (AMR) effect but also those having a GMR element using a giant magneto-resistive (GMR) effect and a TuMR element using a tunneling effect, can be used.

The present invention will be described more concretely with respect to Examples thereof.

### EXAMPLES AND COMPARATIVE EXAMPLES

A vacuum chamber in which a glass substrate for a hard disk (HD) was set was evacuated in advance to 1.0×10⁻⁵ (Pa) or less.

Subsequently, a soft magnetic back layer of CoNbZr and an underlayer of NiTa taking an amorphous structure were formed to 50 (nm) and 5 (nm) in thickness, respectively, on the substrate by using sputtering in Ar atmosphere at a gas pressure of 0.6 (Pa).

As an intermediate layer, 80Re20Co film, 60Re40Co film, 80Re20Cr film, 60Re40Cr film, 60Re20Co20Cr film, 95Re5Mg film, 95Re5Zn film, 80Re20Ti film, 40Re40Ru20Co film and 58Re20Co20Cr2Ga film (Examples 1 to 10, all the compositions expressed in atomic percent) were formed. Mixing of Cr in the intermediate layer was performed by revolving the substrate at the time of film forming. That is, the distance from the rotation center of a substrate holder and the substrate center was set to 396 (mm) and the rotational speed of the substrate holder at the time of film forming was set to 160 (rpm). In film forming, the concentration of Cr existing in the film was controlled by arbitrarily adjusting the discharge outputs from two targets. The composition of the Cr alloy was obtained by examining in advance the relationship between the film deposition rate and the discharge output with respect to each target and by performing computation using factors including the discharge output and discharge time during film forming. Adjustments were made so that the intermediate layer film thickness was 20 (nm).

For Comparative Examples, 100Ru film, 100Zr film, 64Ru16Re20Co film, 100Re film, 70Co30Re film, 70Al30Re film, 49Co30Cr15Pt2Ta4Re film, 51Co30Cr15Pt4Re film (Comparative Examples 1 to 8, all these alloys having hcp structure, all the compositions expressed in atomic percent) conventionally used as intermediate layers were formed to 20 nm. The gas pressure of Ar at the time of film forming was set to 10 (Pa).

On the surfaces of the specimens, film of Co—Cr—Pt—SiO₂ and C film were formed as a magnetic recording layer and a protective layer, respectively, thus forming magnetic recording mediums.

A lubricant was applied to the obtained perpendicular magnetic recording mediums (Examples 1 to 10, Comparative Examples 1 to 8), and the recording and reproducing characteristics of the mediums were evaluated by using Read-Write Analyzer 1632 and Spinstand S1701MP, products from GUZIK Technical Enterprises in U.S. Evaluations of the static magnetic characteristics were thereafter made by using a Kerr measuring apparatus. To examine crystal alignment of the Co alloy in the magnetic recording layer, the rocking curve of the magnetic layer was measured with an X-ray diffraction apparatus.

Table 1 below shows the results of measurements of the high signal-to-noise ratio: SNR, the coercive force: Hc, Δ(delta)θ50 and the Co grain size obtained from the above-described measurements. Each parameter is an index widely used for evaluation of the performance of perpendicular magnetic recording mediums.

With respect to Examples 1 to 10 shown in Table 1 below, it can be understood that the SNR was improved when the concentration of Re was high. However, the SNR characteristic in the case of 100% Re was lower than that in the case of 100% Ru. This is thought to be due to the fact that the value of Δθ50 was large and the degree of C-axis alignment of Co was low.

On the other hand, in Examples 1 to 10, each of the parameters SNR and Δθ50 was improved. From this result, it is thought that the C-axis alignment of Co in the magnetic film was improved by providing as an additive element the element having Re as a main component and having the hcp structure, the element having Re as a main component and having the bcc structure or both these elements, and the SNR was thereby improved. In Comparative Examples 1 to 8, the effect of the additive element having Re as a main component was not observed and, accordingly, the value of Δθ50 and the SNR were deteriorated. In the case of 100% Ru, the Δθ50 was good but compatibility to the oxide magnetic layer was reduced in comparison with Re, Hc was not adequately secured and, therefore, the SNR was deteriorated.

TABLE 1

| | | SNR: | | |
|---|---|---|---|---|
| | Intermediate | MF/MF | Hc | Δθ50 |
| Specimen | layer | (dB) | (Oe) | (deg) |
| Example 1 | 80Re20Co | 16.75 | 4132 | 5.54 |
| Example 2 | 60Re40Co | 16.54 | 4090 | 5.64 |
| Example 3 | 80Re20Cr | 16.72 | 3988 | 5.58 |
| Example 4 | 60Re40Cr | 16.48 | 3947 | 5.53 |
| Example 5 | 60Re20Co20Cr | 16.77 | 4167 | 5.65 |
| Example 6 | 95Re5Mg | 16.44 | 3923 | 5.78 |
| Example 7 | 95Re5Zn | 16.51 | 3955 | 5.71 |
| Example 8 | 80Re20Ti | 18.45 | 3902 | 5.94 |
| Example 9 | 40Re40Ru20Co | 16.77 | 4134 | 5.72 |
| Example 10 | 58Re20Co20Cr2Ga | 16.84 | 4151 | 5.61 |
| Comparative Example 1 | 100Ru | 16.23 | 3956 | 5.34 |
| Comparative Example 2 | 100Zr | 14.56 | 3324 | 8.99 |
| Comparative Example 3 | 64Ru16Re20Co | 16.01 | 4023 | 6.35 |
| Comparative Example 4 | 100Re | 16.11 | 4082 | 6.34 |
| Comparative Example 5 | 70Co30Re | 14.20 | 3548 | 8.35 |
| Comparative Example 6 | 70Al30Re | 12.88 | 2822 | No |
| | | | | peak |
| Comparative Example 7 | 49Co30Cr15Pt2Ta4Re | 13.55 | 3100 | 8.11 |
| Comparative Example 8 | 51Co30Cr15Pt4Re | 13.91 | 3233 | 8.45 |

### INDUSTRIAL APPLICABILITY

According to the present invention, a magnetic recording medium can be obtained in which the crystalline structure of a perpendicular magnetic layer, particularly the crystal c-axis of the hcp structure is aligned with an extremely small angular dispersion with respect to the substrate surface, and in which the average grain size of crystal grains constituting the perpendicular magnetic layer is extremely fine, thereby making it possible to provide a hard disk drive of a high recording density. Thus, the present invention is advantageous in terms of industrial applicability.

1. A perpendicular magnetic recording medium comprising at least a soft magnetic back layer, an underlayer, an intermediate layer and a perpendicular magnetic recording layer on a nonmagnetic substrate, wherein at least one layer in the intermediate layer contains Re as a main component element and contains, as a second main component element, an element having an hcp structure or an element having a bcc structure.

2. The perpendicular magnetic recording medium according to claim 1, wherein the concentration of Re as a main component element of the intermediate layer is within the range from 55 to 99.5 atomic percent.

3. The perpendicular magnetic recording medium according to claim 1, wherein the second main component element is Co or Cr.

4. The perpendicular magnetic recording medium according to claim 1, wherein the concentration of the second main component element is within the range from 0.5 to 45 atomic percent.

5. The perpendicular magnetic recording medium according to claim 1, wherein at least one layer in the intermediate layer contains Re as a main component element and contains, as additive elements, two elements Co and Cr, and the total concentration of the additive elements is within the range from 5 to 45 atomic percent.

6. The perpendicular magnetic recording medium according to claim 5, wherein the content concentrations of Co and Cr are equal to each other.

7. The perpendicular magnetic recording medium according to claim 1, wherein the intermediate layer contains at least one element selected from the 13th-group elements (B, Al, Ga, In, Ti) and 14th-group elements (C, Si, Ge, Sn, Pb) and the total content of the selected element or the sum total of the contents of the selected elements is higher than 0 atomic percent and equal to or lower than 30 atomic percent.

8. A method of manufacturing the perpendicular magnetic recording medium according to claim 1, wherein a sputtering gas pressure is set to 3 Pa or higher at the time of sputtering film forming of the intermediate layer.

9. The method of manufacturing the perpendicular magnetic recording medium according to claim 8, wherein O₂ gas or H₂O gas is added before or after film forming or during film forming at the time of sputtering film forming of the intermediate layer.

10. A magnetic recording and reproducing apparatus comprising a magnetic recording medium and a magnetic head for recording information on the magnetic recording medium and reproducing information from the magnetic recording medium, wherein the magnetic recording medium is the perpendicular magnetic recording medium according to claim 1.

11. The perpendicular magnetic recording medium according to claim 2, wherein the second main component element is Co or Cr.
